(19) United States
(12) Patent Application Publication
(10) Pub. No.: US 2025/0373350 A1
(43) Pub. Date: Dec. 4, 2025

(54) MODEL MONITORING METHODS AND APPARATUS, DEVICE, AND MEDIUM

(71) Applicant: BEIJING XIAOMI MOBILE SOFTWARE CO., LTD., Beijing (CN)

(72) Inventor: Mingju LI, Beijing (CN)

(73) Assignee: BEIJING XIAOMI MOBILE SOFTWARE CO., LTD., Beijing (CN)

(21) Appl. No.: 18/875,417

(22) PCT Filed: Jun. 16, 2022
(86) PCT No.: PCT/CN2022/099197

§ 371 Date: Dec. 16, 2024

(51) Int. Cl. H04B 17/391; H04W 24/06; H04W 72/542

(52) U.S. Cl. CPC H04B 17/3913; H04W 24/06; H04W 72/542

(57) ABSTRACT

The present application belongs to the technical field of communications. Disclosed are model monitoring methods and apparatus, a device and a medium. A method is executed by a terminal, the method comprising monitoring a performance index of a model. The method monitors the performance of a model on the basis of the performance index, such that the terminal performs subsequent steps according to the performance of the model.

### CROSS REFERENCE TO RELATED APPLICATIONS

The present application is a U.S. National Stage of International Application No. PCT/CN2022/099197 filed on Jun. 16, 2022, the content of which is incorporated herein by reference in its entirety.

### TECHNICAL FIELD

The present disclosure relates to the field of communication technologies, in particular, model monitoring methods, apparatuses, devices, and mediums.

### BACKGROUND

An access network device may configure a reference signal resource set for beam measurement. A terminal can measure a reference signal resource in the reference signal resource set, and then report a reference signal resource with strong beam quality and the corresponding beam quality to the access network device, where the beam quality includes Layer1—Reference Signal Received Power (L1-RSRP) and/or Layer1—Signal to Interference plus Noise Ratio (L1-SINR).

In the related art, in order to reduce the measurement of the terminal, beam prediction may be performed based on an Artificial Intelligence (AI) model. For example, beam qualities of some beams obtained by measurement are input into an AI model to predict beam qualities of other beams; or, beam qualities of beams of historical time obtained by measurement are input into an AI model to predict beam qualities of beams of future time.

But the AI model has application conditions and is unstable in model performance.

### SUMMARY

According to one aspect of the present disclosure, there is provided a model monitoring method, performed by a terminal and including:
monitoring a performance index of a model.

According to one aspect of the present disclosure, there is provided a model monitoring method, performed by an access network device and including:
receiving a performance indication reported by a terminal, where the performance indication represents that the terminal monitors a performance index of a model is lower than a threshold of the performance index.

According to another aspect of the present disclosure, there is provided a terminal, including:
a processor;
a transceiver connected with the processor;
where the processor is configured to load and execute the executable instructions to cause the terminal to perform operations including: monitoring a performance index of a model.

According to another aspect of the present disclosure, there is provided an electronic device, including:
a processor;
a transceiver connected with the processor;
where the processor is configured to load and execute the executable instructions to cause the access network device to perform any one model monitoring method mentioned above.

According to one aspect of the present disclosure, there is provided a computer readable storage medium, storing at least one instruction, at least one segment of program, a code set or an instruction set, where the at least one instruction, the at least one segment of program, the code set or the instruction set is loaded or executed by a processor to cause a communication device to perform the above model monitoring methods.

### BRIEF DESCRIPTION OF DRAWINGS

In order to more clearly illustrate the technical solutions of the embodiments of the present disclosure, drawings required for descriptions of embodiments will be briefly introduced below. Apparently, the drawings described herein are only some embodiments of the present disclosure. Other drawings can be obtained by those skilled in the arts based on these drawings without carrying out creative effort.

FIG. 1 is a schematic diagram illustrating a communication system according to an example.

FIG. 2 is a schematic flowchart illustrating a model monitoring method according to an example.

FIG. 3 is a schematic diagram illustrating a model monitoring method according to an example.

FIG. 4 is a schematic flowchart illustrating a model monitoring method according to an example.

FIG. 5 is a schematic flowchart illustrating a model monitoring method according to an example.

FIG. 6 is a schematic flowchart illustrating a model monitoring method according to an example.

FIG. 7 is a schematic flowchart illustrating a model monitoring method according to an example.

FIG. 8 is a schematic diagram illustrating a model monitoring method according to an example.

FIG. 9 is a schematic diagram illustrating a model monitoring method according to an example.

FIG. 10 is a schematic flowchart illustrating a model monitoring method according to an example.

FIG. 11 is a schematic flowchart illustrating a model monitoring method according to an example.

FIG. 12 is a schematic flowchart illustrating a model monitoring method according to an example.

FIG. 13 is a schematic flowchart illustrating a model monitoring method according to an example.

FIG. 14 is a block diagram illustrating a model monitoring apparatus according to an example.

FIG. 15 is a block diagram illustrating a model monitoring apparatus according to an example.

FIG. 16 is a structural schematic diagram illustrating a terminal according to an example.

FIG. 17 is a structural schematic diagram illustrating an access network device according to an example.

### DETAILED DESCRIPTION

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

Network architectures and service scenarios described in the embodiments of the present disclosure are used to more clearly illustrate the technical solutions of the embodiments of the present disclosure and do not constitute any limitation to the technical solutions of the embodiments of the present disclosure. Those persons of ordinary skills in the arts can know, along with evolution of the network architectures and appearance of new service scenarios, the technical solutions of the embodiments of the present disclosure are also applicable to similar technical problems.

One or more embodiments of the present disclosure provide model monitoring methods, apparatuses, a device and a medium to realize real-time monitoring on performance of a model so as to help a terminal to perform subsequent steps.

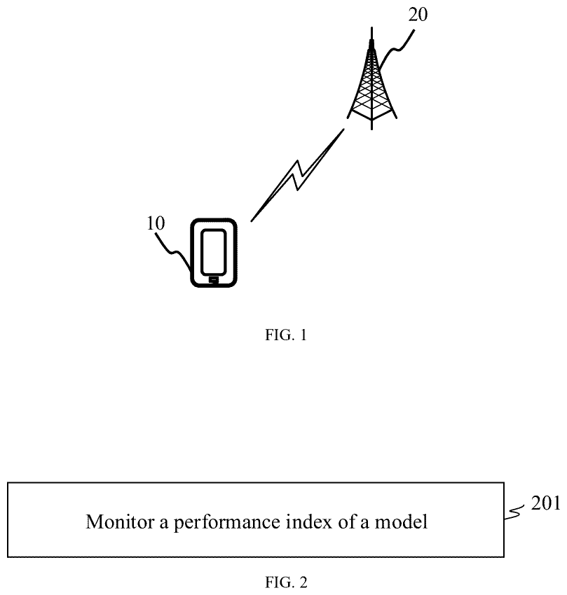

With reference to FIG. 1, FIG. 1 is a schematic diagram illustrating a communication system according to an embodiment of the present disclosure. The communication system includes a terminal 10 and an access network device 20.

There are usually a plurality of terminals 10, and one or more terminals 10 may be distributed in a cell under management of each access network device 20. The terminal 10 may include a hand-held device, a vehicle-mounted device, a wearable device and a computer device having wireless communication function or other processing devices connected to a wireless modem, and various types of user equipments (UE) and Mobile Stations (MS) and the like. For ease of descriptions, the above devices referred to in the embodiments of the present disclosure are all referred to as terminals.

The access network device 20 is an apparatus deployed in an access network to provide wireless communication function for the terminal 10. The access network device 20 may include various types of macro base stations, micro base stations, repeater stations and access points. In systems employing different wireless access technologies, devices having functions of access network device may have different names. For example, in a 5G NR system, the devices are called gNodeB or gNB. Along with evolution of a communication technology, the name “access network device” may change. For ease of descriptions, in the embodiments of the present disclosure, the above apparatuses providing wireless communication function for the terminal 10 are all called access network devices. A connection between the access network device 20 and the terminal 10 may be established by air interface so as to perform communication via the connection, including performing interaction of signaling or data. There may be a plurality of access network devices 20, and two adjacent access network devices 20 can also communicate with each other in a wired or wireless manner. The terminal 10 may perform a handover among different access network devices 20, namely, may establish connection with different access network devices 20.

A “5G NR system” in the embodiments of the present disclosure can also be referred to as a 5G system or NR system which can be understood by those skilled in the art. The technical solutions described in the embodiments of the present disclosure can be applied to the 5G NR system or to evolving systems following the 5G NR system.

In a New Radio (NR) technology, especially when a communication frequency band is in a frequency range 2, because a high-frequency channel has rapid attenuation, it is required to employ beam-based sending and reception in order to ensure coverage.

FIG. 2 is a flowchart illustrating a model monitoring method according to an embodiment of the present disclosure. The method may be applied to a terminal in a communication system shown in FIG. 1. The method may include the following steps.
At step 201, a performance index of a model is monitored.

In an example, a model used in the embodiments of the present disclosure includes at least one of an AI model, a mathematics model or a machine learning model, which is not limited herein. The embodiments of the present disclosure are described with the model as the AI model. For example, the terminal monitors the performance index of the AI model.

Beam prediction is used to predict a beam quality of a beam. In a specific example, the access network device may configure a reference signal set for beam measurement. Each reference signal in the reference signal set corresponds to a different sent beam of the access network device. The terminal performs measurement on each reference signal in the reference signal set and then reports X number of reference signal identifiers with strong beam quality and corresponding beam qualities. The beam quality includes Layer1—Reference Signal Received Power (L1-RSRP) and/or Layer1—Signal to Interference plus Noise Ratio (L1-SINR).

With assistance of the AI model, if a number of beam pairs for which the terminal needs to obtain beam qualities is M*N (M is a number of sent beams of the access network device and N is a number of received beams of the terminal), the terminal only needs to measure beam qualities of P beam pairs (P is less than M*N) in the M*N beam pairs, and then inputs measured beam qualities of the P beam pairs into the AI model. Thus, the AI model can output beam qualities of the M*N beam pairs. One beam pair includes one sent beam of the access network device and one received beam of the terminal. The sent beam of the access network device corresponds to one reference signal ID.

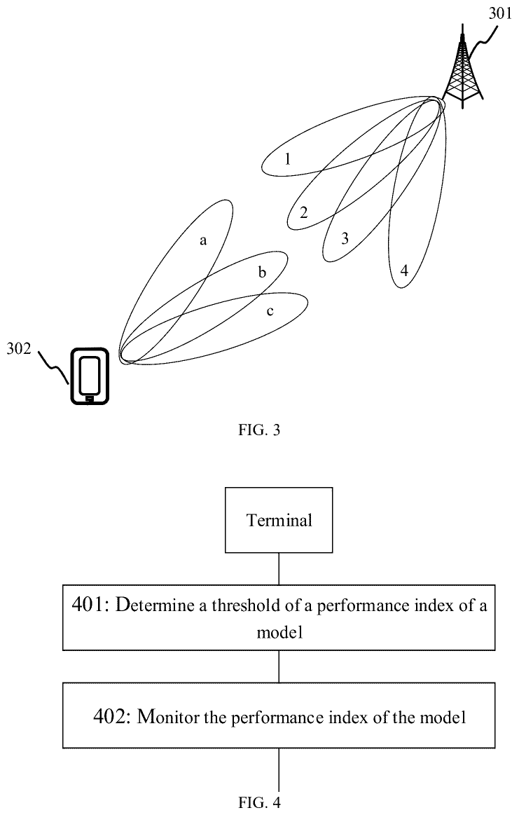

For example, as shown in FIG. 3, the sent beams of the access network device 301 include a beam 1, a beam 2, a beam 3 and a beam 4, and the received beams of the terminal 302 include a beam a, a beam b, and a beam c. In this case, the beam pairs for which the terminal needs to obtain beam qualities include “beam 1-beam a,” “beam 1-beam b,” “beam 1-beam c,” “beam 2-beam a,” “beam 2-beam b,” “beam 2-beam c,” “beam 3-beam a,” “beam 3-beam b,” “beam 3-beam c,” “beam 4-beam a,” “beam 4-beam b,” and “beam 4-beam c,” totalling 12 cases. Therefore, the terminal only needs to measure the beam qualities of “beam 1-beam a,” “beam 2-beam b,” “beam 3-beam c” and “beam 4-beam c” and then input the measured beam qualities into the AI model. The AI model can output the beam qualities for all 12 beam pairs.

In one possible embodiment, the terminal measures the L1-RSRP and/or L1-SINR of the reference signal, and the reference signal includes at least one of Synchronization Signal/PBCH Block (SSB), Channel State Information Reference Signal (CSI-RS) or Sounding Reference Signal (SRS).

In one possible embodiment, the terminal can, based on Transmission Configuration Indication state (TCI state), determine beams of a channel and/or a reference signal transmitted by the access network device. The TCI state includes at least one Quasi Co-Location (QCL) type, and the QCL type includes at least one of Type A, Type B, Type C or Type D. The Type A, the Type B and the Type C include at least one of parameters related to Doppler shift, Doppler spread, average delay and delay spread. The type D is reception parameter information also called beam information.

In one possible embodiment, the monitored performance index includes at least one of the following items.
(1) Prediction accuracy: a probability that N strongest reference signal identifiers predicted by the AI model include actual strongest reference signal identifiers, where the reference signal identifier is at least one of the SSB identifier, the CSI-RS identifier or the SRS identifier. A strongest reference signal refers to a reference signal with largest L1-RSRP or L1-SINR, and N is a positive integer. The N strongest reference signal identifiers predicted by the AI model refer to N reference signal identifiers predicted by the AI model and ranked top N in beam quality. In an example, an actual strongest reference signal identifier refers to a reference signal identifier ranked first in beam quality after the terminal measures the beam qualities of all reference signals.
(2) L1-RSRP average difference: a difference between an actual L1-RSRP corresponding to the strongest reference signal identifier predicted by the AI model and an actual L1-RSRP corresponding to the actual strongest reference signal identifier. If the strongest reference signal identifier predicted by the AI model is same as the actual strongest reference signal identifier, the L1-RSRP difference is 0. The L1-RSRP average difference can be obtained by a single prediction result based on the AI model, or by an average value of multiple prediction results based on the AI model.
(3) L1-SINR average difference: a difference between an actual L1-SINR corresponding to the strongest reference signal identifier predicted by the AI model and an actual L1-SINR corresponding to the actual strongest reference signal identifier. If the strongest reference signal identifier predicted by the AI model is same as the actual strongest reference signal identifier, the L1-SINR difference is 0. The L1-SINR average difference can be obtained by a single prediction result based on the AI model, or by an average value of multiple prediction results based on the AI model.
(4) Target L1-RSRP difference corresponding to a first percentile of a cumulative distribution function (CDF) curve of a L1-RSRP difference: in one implementation, the CDF curve of a L1-RSRP difference is a CDF curve obtained by the L1-RSRP differences of multiple prediction results based on the AI model in the above (2), namely, the L1-RSRP difference only includes a difference between the actual L1-RSRP corresponding to the strongest reference signal identifier predicted by the AI model and the actual L1-RSRP corresponding to the actual strongest reference signal identifier. In another implementation, the L1-RSRP difference refers to a difference between a predicted L1-RSRP corresponding to each reference signal identifier predicted at least once by the AI model and the actual L1-RSRP corresponding to each actual reference signal identifier, respectively, that is, the AI model needs to output the L1-RSRP corresponding to each reference signal identifier. The first percentile is any percentile on the CDF curve of a L1-RSRP difference. In an example, the first percentile may be preconfigured by the access network device, for example, as 5%, 50% or 95%.
(5) Target L1-SINR difference corresponding to a second percentile of a CDF curve of a L1-SINR difference: In one implementation, the CDF curve of a L1-SINR difference is a CDF curve obtained by the L1-SINR differences of multiple prediction results based on the AI model in the above (3), namely, the L1-SINR difference only includes the difference between the actual L1-SINR corresponding to the strongest reference signal identifier predicted by the AI model and the actual L1-SINR corresponding to the actual strongest reference signal identifier. In another implementation, the L1-SINR difference refers to a difference between a predicted L1-SINR corresponding to each reference signal identifier predicted by the AI model at least once and the actual L1-SINR corresponding to each actual reference signal identifier, that is, the AI model needs to output the L1-SINR corresponding to each reference signal identifier. The second percentile is any percentile on the CDF curve of a L1-SINR difference. In an example, the second percentile may be preconfigured by the access network device, for example, as 5%, 50% or 95%.
(6) Average UE throughput difference: based on the actual L1-RSRP corresponding to the strongest reference signal identifier predicted by the AI model and the actual L1-RSRP corresponding to the actual strongest reference signal identifier, SINRs corresponding to two reference signal identifiers respectively are obtained, and Shannon capacities corresponding to the two reference signal identifiers respectively are calculated and therefore a difference between the Shannon capacities corresponding to the two reference signal identifiers respectively is this performance index. This performance index may be obtained by a single prediction result based on the AI model or by multiple prediction results based on the AI model.

In one possible embodiment, when the terminal monitors that the performance index of the AI model is less than a threshold of the performance index, the terminal reports a performance indication to the access network device, where the performance indication is used to notify the access network device that the AI model has a poor performance. Further, the performance indication is further used to request the access network device to send an indication for updating the AI model.

In one possible embodiment, when the terminal monitors that the performance index of the AI model is less than the threshold of the performance index, the terminal updates the AI model by itself. After the terminal completes update on the AI model, the terminal reports an update result of the AI model to the access network device. In an example, the update result of the AI model includes at least one of an updated model identifier, an updated model parameter configuration, an updated model parameter configuration identifier or an updated version identifier.

In conclusion, in the embodiments of the present disclosure, the performance index of the model is monitored such that the terminal can perform subsequent steps based on the performance of the model, so as to improve the performance of performing beam prediction based on AI model.

FIG. 4 is a flowchart illustrating a model monitoring method according to an embodiment of the present disclosure. The method may be applied to a terminal in a communication system shown in FIG. 1. The method includes the following steps.
At step 401, the terminal determines a threshold of a performance index of a model.
At step 402, the terminal monitors the performance index of the model.

In one possible embodiment, the model used in the embodiments of the present disclosure includes at least one of an AI model, a mathematics model or a machine learning model, which is not limited herein. The embodiments of the present disclosure are described with the model as the AI model. For example, the terminal monitors the performance index of the AI model.

In one possible embodiment, for the step 401, the threshold of the performance index may be preconfigured by the access network device, or the threshold of the performance index may be a pre-agreed default value. For example, the access network device may send indication information in advance to the terminal, where the indication information is used for the terminal to determine the threshold of the performance index of the model. In an example, the indication information includes at least one of Downlink Control Information (DCI), Medium Access Control Control Element (MAC CE) or Radio Resource Control (RRC).

In one possible embodiment, for the step 402, the terminal may determine the performance index based on at least one prediction result output by the model within a first preset time. The first preset time may be indicated by the access network device to the terminal or determined based on a default value. For example, when the first preset time is set to 1 second, if the AI model outputs 3 prediction results within the 1 second, the performance index of the AI model is determined based on the three prediction results.

In one possible embodiment, for the step 402, the terminal may determine the performance index based on N1 prediction results output by the model, where N1 is a positive integer. N1 may be indicated by the access network device to the terminal or determined based on a default value. For example, if N1=3, three prediction results continuously output by the AI model are obtained and the performance index is determined based on the three prediction results. For another example, if N1=3 and the AI model outputs 10 prediction results within a period of time, three prediction results may be selected randomly therefrom to determine the performance index, or three prediction results may be selected therefrom based on a preset rule to determine the performance index.

In one possible embodiment, for the step 402, if the terminal measures beam qualities of a reference signal set B and inputs the measured beam qualities into the AI model to predict beam qualities of a reference signal set A. The beam quality is L1-RSRP and/or L1-SINR.

In one circumstance, the terminal does not need to monitor the performance of the AI model, that is, training for the AI model has been completed. In this case, the access network device only needs to periodically send the reference signals of the reference signal set B (for example, send the reference signals of the reference signal set B based on a first period), and then the terminal measures L1-RSRPs and/or L1-SINRs of the reference signals of the reference signal set B and inputs them into the AI model so as to output L1-RSRPs and/or L1-SINRs of the reference signal set A or output X reference signal identifiers (X is a positive integer) with the strongest beam qualities in the reference signal set A.

In another circumstance, the terminal needs to monitor the performance of the AI model. In this case, the access network device is required to periodically send the reference signals in the reference signal set A (for example, send the reference signals in the reference signal set A based on a second period, where the second period may be greater than or less than the first period, for example, the second period is a multiple of the first period or the first period is a multiple of the second period, which is not limited herein); and then, the terminal measures the L1-RSRPs and/or L1-SINRs of the reference signals in the reference signal set B and then inputs the L1-RSRPs and/or L1-SINRs of the reference signals in the reference signal set B into the AI model to obtain predicted strongest reference signal identifiers (further including predicted L1-RSRPs and/or L1-SINRs) and at the same time, the terminal measures the L1-RSRPs and/or L1-SINRs of all reference signals in the reference signal set A to determine the actual strongest reference signal identifiers, and then compares the predicted strongest reference signal identifiers with the actual strongest reference signal identifiers, or obtain the above other performance index, and then compares the performance index with the performance index threshold to determine whether to report the performance indication to the access network device. In an example, the reference signal set A is close to the latest reference signal set B in sending time.

For example, as shown in FIG. 8, the terminal receives the reference signals of the reference signal set B at a frequency of the first period and receives the reference signals of the reference signal set A at a frequency of the second period, where the first period is less than the second period. As shown in FIG. 8, the terminal, when receiving the reference signal set A and the reference signal set B at the same time, can monitor the performance of the model. But, the terminal, when only receiving the reference signal set B, does not need to monitor the performance of the model.

In one possible embodiment, for the step 402, the terminal inputs the L1-RSRPs and/or L1-SINRs of the reference signals in a first set at a first time into the AI model to obtain absolute values and/or relative relationships of the L1-RSRPs and/or L1-SINRs of the reference signals in a second set at a second time, where the first set is a subset of the second set. The first set and the second set may be the same set or the first set is a proper subset of the second set. In an example, the first time is a historical time and the second time is a time after the first time. For example, the second set includes 32 reference signals of the second time, and the first set includes 8 reference signals of the first time, and thus the terminal can predict beam qualities of 32 reference signals of the second time by using beam qualities of 8 reference signals of the first time based on the AI model.

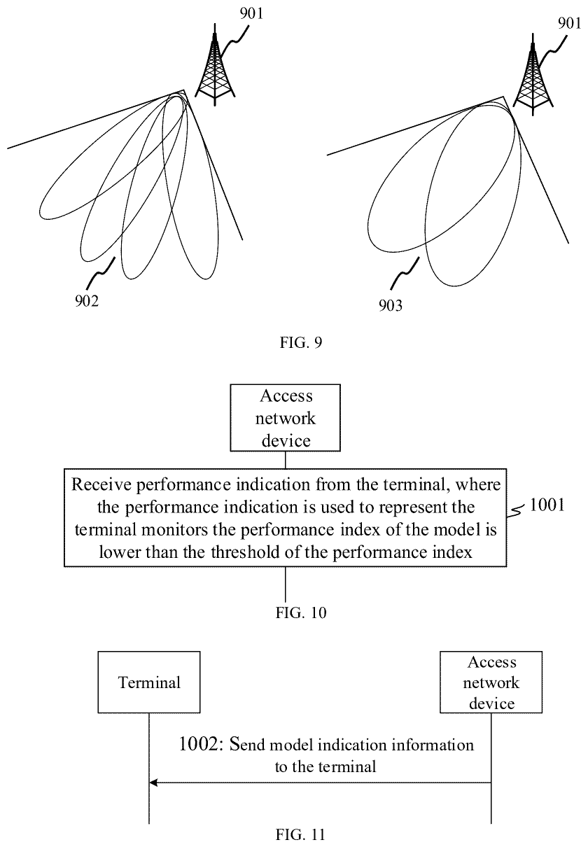

In one possible embodiment, for the step 402, the terminal inputs L1-RSRPs and/or L1-SINRs of reference signals in a third set at the first time into the AI model to obtain absolute values and/or relative relationships of L1-RSRPs and/or L1-SINRs of reference signals in a fourth set at the second time. Beam widths of the reference signals in the third set are greater than beam widths of the reference signals in the fourth set, and a beam direction of each reference signal in the third set covers beam directions of multiple reference signals in the fourth set. For example, the fourth set includes 32 reference signals and each reference signal corresponds to one beam direction. The 32 reference signals cover a direction of 120 degrees. The third set includes N reference signals, where each reference signal also covers the direction of 120 degrees. It can also be thought that 32/N reference signals in the fourth set are in QCL Type D relationship with a sane reference signal in the third set. For example, as shown in FIG. 9, the fourth set 902 provided by the access network device 901 includes 4 reference signals which cover the beam direction of 120 degrees. Furthermore, the third set 903 provided by the access network device 901 includes 2 reference signals which cover a same beam direction as the above 4 reference signals covering 120 degrees. In an example, the first time and the second time are in a same period, and the above “period” is used for a sending period of reference signals for the beam measurement or a reporting period of beam measurement reporting.

In an example, the first time and the second time are not in a same period, for example, the first time is a historical time and the second time is a future time. It can be understood that the beam quality of the future time is predicted using the beam quality measured in the historical time.

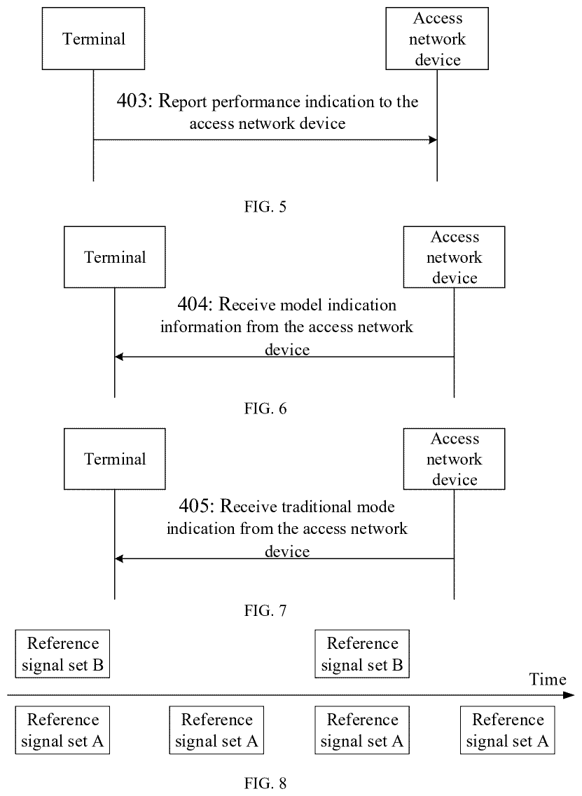

In one possible embodiment, as shown in FIG. 5, the embodiment of the present disclosure further includes: at step 403, reporting, by the terminal, a performance indication to the access network device.

In one possible embodiment, for the step 403, when it is monitored that performance index of the model is lower than the threshold of the performance index, the performance indication is reported to the access network device.

The method of reporting the performance indication includes at least one of the following methods:
(1) reporting the performance indication to the access network device over Physical Uplink Control Channel (PUCCH) or Physical Uplink Shared Channel (PUSCH);
(2) reporting the performance indication to the access network device by using information carrying Channel State Information (CSI); where the CSI is used to feed back at least one of Precoding Matrix Indication (PMI), Rank Indication (RI), Layer Indication (LI), CSI-RS Resource Indication (CRI), L1-RSRP or L1-SINR;
(3) reporting, by the terminal, the performance indication to the access network device by UpLink Medium Access Control Control Element (UL MAC CE) and/or Scheduling Request (SR).

In one possible embodiment, for the step 403, the performance indication includes at least one of the followings.
(1) Indication for poor performance of the model

In an example, a specific SR is defined for use at the time of poor performance of the model, that is, the SR indicates the poor performance of the AI model. In an example, a specific MAC CE is defined for use at the time of poor performance of the model, that is, the MAC CE indicates the poor performance of the model. In an example, bit is used to indicate that the performance of the AI model is good or poor. For example, “1” is used to indicate that the performance index of the AI model is higher than the threshold of the performance index, representing that the performance of the AI model is good. “0” is used to indicate that the performance index of the AI model is lower than the threshold of the performance index, representing that the performance of the AI model is poor.
(2) Performance index value of the model

In an example, the performance index value refers to a numerical size of the performance index of the AI model.
(3) At least one of a model identifier, a version identifier, a parameter configuration identifier or a parameter configuration of the model

In an example, the model identifier is used to identify the AI model from multiple AI models. For example, the model identifiers include identifiers corresponding to the models with different functions. For example, the AI model is used for CSI compression, or the AI model is used for beam measurement or the AI model is used for positioning prediction.

In an example, the version identifier is used to identify a model version from multiple versions of the AI model. For example, the AI model includes four model versions which can be identified using “00,” “01,” “10” and “11”.

In an example, the parameter configuration identifier is used to identify a parameter configuration from multiple parameter configurations of the AI model.

In an example, the parameter configuration is used to represent network parameters of the AI model.
(4) At least one of a model identifier, a version identifier, a parameter configuration identifier or a parameter configuration of a recommended model

In an example, the recommended model refers to an updated AI model recommended by the terminal.
(5) Recommendation for returning to a traditional mode

In an example, the traditional mode refers to a non-AI mode or that the model identifier of the non-AI mode is 0.

In one possible embodiment, for the step 403, model indication information includes at least one of Downlink Control Information (DCI), Medium Access Control Control Element (MAC CE), or Radio Resource Control (RRC).

In one possible embodiment, as shown in FIG. 6, an embodiment of the present disclosure further includes: at step 404, receiving, by the terminal, the model indication information from the access network device.

In an example, the terminal updates the model based on the model indication information; or switches the model into the recommended model.

In one possible embodiment, for the step 404, the model indication information is used to indicate at least one of a model parameter configuration identifier, a model parameter configuration, a model identifier or a model version identifier.

For example, the access network device provides, in advance, a correspondence of a model identifier and a model parameter to the terminal by an RRC signaling. The MAC CE or DCI is used to indicate the model identifier such that the terminal can determine the model parameter based on the model indication information.

For example, the access network device provides, in advance, a correspondence of a model version identifier and a model parameter to the terminal by an RRC signaling. The MAC CE or DCI is used to indicate the model version identifier such that the terminal can determine the model parameter based on the model indication information.

For example, the access network device provides, in advance, a correspondence of a model parameter configuration identifier and a model parameter to the terminal by an RRC signaling. The MAC CE or DCI is used to indicate the model parameter configuration identifier such that the terminal can determine the model parameter based on the model indication information.

For example, the access network device provides, in advance, a correspondence of a model identifier and a model parameter to the terminal by an RRC signaling. The MAC CE is used to activate some model identifiers and the DCI is used to activate one model identifier of the some model identifiers such that the terminal can determine the model parameter based on the model indication information.

For example, the access network device provides, in advance, a correspondence of a model version identifier and a model parameter to the terminal by an RRC signaling. The MAC CE is used to activate some model version identifiers and the DCI is used to activate one model version identifier of the some model version identifiers such that the terminal can determine the model parameter based on the model indication information.

For example, the access network device provides, in advance, a correspondence of a model parameter configuration identifier and a model parameter to the terminal by an RRC signaling. The MAC CE is used to activate some model parameter configuration identifiers and the DCI is used to activate one model parameter configuration identifier of the some parameter configuration identifiers such that the terminal can determine the model parameter based on the model indication information.

In one possible embodiment, as shown in FIG. 7, an embodiment of the present disclosure further includes: at step 405, receiving, by the terminal, a traditional mode indication of the access network device.

In an example, the terminal switches to the traditional mode based on the traditional mode indication. The traditional mode indication is used to indicate the terminal to use the traditional mode. In an example, the traditional mode refers to a non-AI mode or to that the model identifier of the non-AI mode is 0.

It should be noted that an embodiment of the present disclosure includes multiple selectable steps and each step includes at least one embodiment. Each step may be independent as one embodiment or each step may be split into multiple embodiments or multiple steps form one embodiment. For example, the above step 403 may be formed into one embodiment separately, or the step 403 may also be split into multiple embodiments in the above multiple possible embodiments, or the steps 403 and 404 are jointly formed into one embodiment. No specific limitation is made in the embodiments of the present disclosure.

To sum up, in the embodiments of the present disclosure, the performance index of the model can be monitored and the terminal can report the identifiers and performance indexes of the reference signals obtained by model prediction to the access network device. If the access network device monitors based on the identifiers and performance indexes of the reference signals that the model performance is poor, the access network device may send the model indication information to the terminal to improve the performance of beam quality prediction based on AI model.

FIG. 10 is a flowchart illustrating a model monitoring method according to an embodiment of the present disclosure. The method may be applied to an access network device in a communication system shown in FIG. 1. The method includes the following steps.
At step 1001, an access network device receives a performance indication reported by a terminal, where the performance indication is used to represent that the terminal monitors a performance index of a model is lower than a threshold of the performance index.

In one possible embodiment, the model used in the embodiment of the present disclosure is at least one of an AI model, a mathematics model or a machine learning model, which is not limited herein. The embodiment of the present disclosure is described with the model as the AI model.

In an example, the performance indication is reported to the access network device when the terminal monitors that the performance index of the model is lower than the threshold of the performance index. In an example, the access network device sends, in advance, indication information to the terminal. The indication information is used for the terminal to determine the threshold of the performance index of the model. Alternatively, the threshold of the performance index is a pre-agreed default value.

In one possible embodiment, the performance index includes at least one of the followings.
(1) Prediction accuracy: a probability that N strongest reference signal identifiers predicted by the AI model include actual strongest reference signal identifiers, where the reference signal identifier is at least one of the SSB identifier, the CSI-RS identifier or the SRS identifier. A strongest reference signal refers to a reference signal with largest L1-RSRP or L1-SINR, and N is a positive integer. The N strongest reference signal identifiers predicted by the AI model refer to N reference signal identifiers predicted by the AI model and ranked top N in beam quality. In an example, an actual strongest reference signal identifier refers to a reference signal identifier ranked first in beam quality after the terminal measures the beam qualities of all reference signals.
(2) L1-RSRP average difference: a difference between an actual L1-RSRP corresponding to the strongest reference signal identifier predicted by the AI model and an actual L1-RSRP corresponding to the actual strongest reference signal identifier. If the strongest reference signal identifier predicted by the AI model is same as the actual strongest reference signal identifier, the L1-RSRP difference is 0. The L1-RSRP average difference can be obtained by a single prediction result based on the AI model, or by an average value of multiple prediction results based on the AI model.
(3) L1-SINR average difference: a difference between an actual L1-SINR corresponding to the strongest reference signal identifier predicted by the AI model and an actual L1-SINR corresponding to the actual strongest reference signal identifier. If the strongest reference signal identifier predicted by the AI model is same as the actual strongest reference signal identifier, the L1-SINR difference is 0. The L1-SINR average difference can be obtained by a single prediction result based on the AI model, or by an average value of multiple prediction results based on the AI model.
(4) Target L1-RSRP difference corresponding to a first percentile of a cumulative distribution function (CDF) curve of a L1-RSRP difference: in one implementation, the CDF curve of a L1-RSRP difference is a CDF curve obtained by the L1-RSRP differences of multiple prediction results based on the AI model in the above (2), namely, the L1-RSRP difference only includes a difference between the actual L1-RSRP corresponding to the strongest reference signal identifier predicted by the AI model and the actual L1-RSRP corresponding to the actual strongest reference signal identifier. In another implementation, the L1-RSRP difference refers to a difference between a predicted L1-RSRP corresponding to each reference signal identifier predicted at least once by the AI model and the actual L1-RSRP corresponding to each actual reference signal identifier, respectively, that is, the AI model needs to output the L1-RSRP corresponding to each reference signal identifier. The first percentile is any percentile on the CDF curve of a L1-RSRP difference. In an example, the first percentile may be preconfigured by the access network device, for example, as 5%, 50% or 95%.
(5) Target L1-SINR difference corresponding to a second percentile of a CDF curve of a L1-SINR difference: In one implementation, the CDF curve of a L1-SINR difference is a CDF curve obtained by the L1-SINR differences of multiple prediction results based on the AI model in the above (3), namely, the L1-SINR difference only includes the difference between the actual L1-SINR corresponding to the strongest reference signal identifier predicted by the AI model and the actual L1-SINR corresponding to the actual strongest reference signal identifier. In another implementation, the L1-SINR difference refers to a difference between a predicted L1-SINR corresponding to each reference signal identifier predicted by the AI model at least once and the actual L1-SINR corresponding to each actual reference signal identifier, that is, the AI model needs to output the L1-SINR corresponding to each reference signal identifier. The second percentile is any percentile on the CDF curve of a L1-SINR difference. In an example, the second percentile may be preconfigured by the access network device, for example, as 5%, 50% or 95%.
(6) Average UE throughput difference: based on the actual L1-RSRP corresponding to the strongest reference signal identifier predicted by the AI model and the actual L1-RSRP corresponding to the actual strongest reference signal identifier, SINRs corresponding to two reference signal identifiers respectively are obtained, and Shannon capacities corresponding to the two reference signal identifiers respectively are calculated and therefore a difference between the Shannon capacities corresponding to the two reference signal identifiers respectively is this performance index. This performance index may be obtained by a single prediction result based on the AI model or by multiple prediction results based on the AI model.

In one possible implementation, the performance indication includes at least one of the followings.
(1) Indication for poor performance of the model

In an example, a specific SR is defined for use at the time of poor performance of the model, that is, the SR indicates the poor performance of the AI model. In an example, a specific MAC CE is defined for use at the time of poor performance of the model, that is, the MAC CE indicates the poor performance of the model. In an example, bit is used to indicate that the performance of the AI model is good or poor. For example, “1” is used to indicate that the performance index of the AI model is higher than the threshold of the performance index, representing that the performance of the AI model is good. “0” is used to indicate that the performance index of the AI model is lower than the threshold of the performance index, representing that the performance of the AI model is poor.
(2) Performance index value of the model

In an example, the performance index value refers to a numerical size of the performance index of the AI model.
(3) At least one of a model identifier, a version identifier, a parameter configuration identifier or a parameter configuration of the model

In an example, the model identifier is used to identify the AI model from multiple AI models. For example, the model identifiers include identifiers corresponding to the models with different functions. For example, the AI model is used for CSI compression, or the AI model is used for beam measurement or the AI model is used for positioning prediction.

In an example, the version identifier is used to identify a model version from multiple versions of the AI model. For example, the AI model includes four model versions which can be identified using “00,” “01,” “10” and “11”.

In an example, the parameter configuration identifier is used to identify a parameter configuration from multiple parameter configurations of the AI model.

In an example, the parameter configuration is used to represent network parameters of the AI model.
(4) At least one of a model identifier, a version identifier, a parameter configuration identifier or a parameter configuration of a recommended model

In an example, the recommended model refers to an updated AI model recommended by the terminal.
(5) Recommendation for returning to a traditional mode

In an example, the traditional mode refers to a non-AI mode or that the model identifier of the non-AI mode is 0.

In one possible embodiment, the access network device receives the performance indication reported by the terminal by:
(1) The access network device receives, over the PUCCH or PUSCH, the performance indication reported by the terminal.
(2) The access network device, by using the information carrying the CSI, receives the performance indication reported by the terminal. The CSI is a feedback method for feeding back at least one of PMI, RI, LI, CRI, L1-RSRP or L1-SINR.
(3) The access network device receives, by UL MAC CE and/or SR, the performance indication reported by the terminal.

In one possible embodiment, as shown in FIG. 11, an embodiment of the present disclosure further includes: at step 1002, sending, by the access network device, model indication information to the terminal.

In an example, the model indication information is used to indicate at least one of a model parameter configuration identifier, a model parameter configuration, a model identifier or a model version identifier. The model indication information is used to indicate the terminal to update the model.

In an example, the model indication information is transmitted by at least one of DCI, MAC CE or RRC.

For example, the access network device provides, in advance, a correspondence of a model identifier and a model parameter to the terminal by an RRC signaling. The MAC CE or DCI is used to indicate the model identifier such that the terminal can determine the model parameter based on the model indication information. In this way, the terminal can update the model parameter of the AI model.

For example, the access network device provides, in advance, a correspondence of a model version identifier and a model parameter to the terminal by an RRC signaling. The MAC CE or DCI is used to indicate the model version identifier such that the terminal can determine the model parameter based on the model indication information. In this way, the terminal can update the model parameter of the AI model.

For example, the access network device provides, in advance, a correspondence of a model parameter configuration identifier and a model parameter to the terminal by an RRC signaling. The MAC CE or DCI is used to indicate the model parameter configuration identifier such that the terminal can determine the model parameter based on the model indication information. In this way, the terminal can update the model parameter of the AI model.

For example, the access network device provides, in advance, a correspondence of a model identifier and a model parameter to the terminal by an RRC signaling. The MAC CE is used to activate some model identifiers and the DCI is used to activate one model identifier of the some model identifiers such that the terminal can determine the model parameter based on the model indication information. In this way, the terminal can update the model parameter of the AI model.

For example, the access network device provides, in advance, a correspondence of a model version identifier and a model parameter to the terminal by an RRC signaling. The MAC CE is used to activate some model version identifiers and the DCI is used to activate one model version identifier of the some model version identifiers such that the terminal can determine the model parameter based on the model indication information. In this way, the terminal can update the model parameter of the AI model.

For example, the access network device provides, in advance, a correspondence of a model parameter configuration identifier and a model parameter to the terminal by an RRC signaling. The MAC CE is used to activate some model parameter configuration identifiers and the DCI is used to activate one model parameter configuration identifier of the some parameter configuration identifiers such that the terminal can determine the model parameter based on the model indication information. In this way, the terminal can update the model parameter of the AI model.

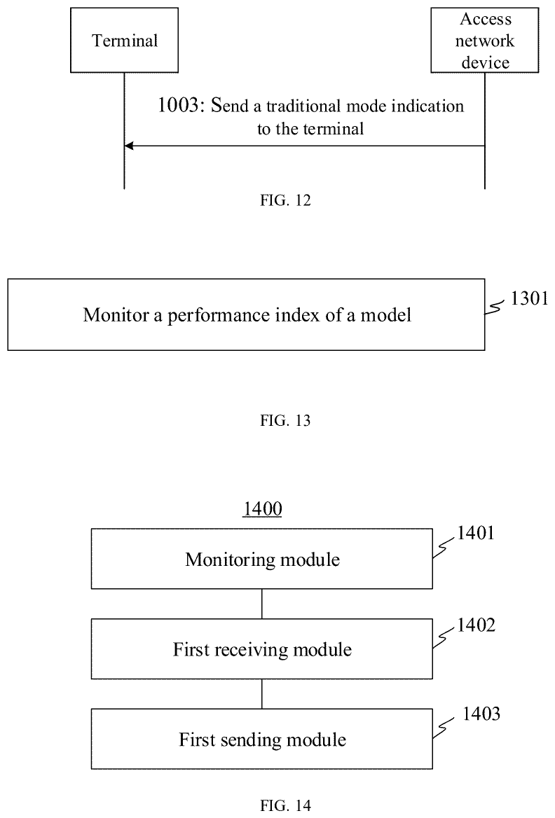

In one possible embodiment, as shown in FIG. 12, an embodiment of the present disclosure further includes: at step 1003, sending, by the access network device, a traditional mode indication to the terminal.

The traditional mode indication is used to indicate the terminal to use a traditional mode. In an example, the traditional mode refers to a non-AI mode or that the model identifier of the non-AI mode is 0.

It should be noted that an embodiment of the present disclosure includes multiple selectable steps and each step includes at least one embodiment. Each step may be independent as one embodiment or each step may be split into multiple embodiments or multiple steps form one embodiment. No specific limitation is made in the embodiments of the present disclosure.

To sum up, in the embodiments of the present disclosure, after the performance index of the model is monitored, the access network device distributes a performance indication to the terminal to allow the terminal to perform subsequent steps, improving the performance of beam quality prediction based on AI model.

In the following embodiments, the model may also be set on the access network device and hence the access network device can perform beam prediction based on the model.

FIG. 13 is a flowchart illustrating a model monitoring method according to an embodiment of the present disclosure. The method may be applied to a communication system shown in FIG. 1. The method may include the following steps.
At step 1301, a performance index of a model is monitored.

In one possible embodiment, the model used in the embodiments of the present disclosure is at least one of an AI model, a mathematics model or a machine learning model, which is not limited herein. The embodiments of the present disclosure are described with the model as the AI model. For example, the AI model is used to perform beam prediction.

In one possible embodiment, the performance index includes at least one of the followings:
(1) Prediction accuracy: a probability that N strongest reference signal identifiers predicted by the AI model include actual strongest reference signal identifiers, where the reference signal identifier is at least one of the SSB identifier, the CSI-RS identifier or the SRS identifier. A strongest reference signal refers to a reference signal with largest L1-RSRP or L1-SINR, and N is a positive integer. The N strongest reference signal identifiers predicted by the AI model refer to N reference signal identifiers predicted by the AI model and ranked top N in beam quality. In an example, an actual strongest reference signal identifier refers to a reference signal identifier ranked first in beam quality after the terminal measures the beam qualities of all reference signals.
(2) L1-RSRP average difference: a difference between an actual L1-RSRP corresponding to the strongest reference signal identifier predicted by the AI model and an actual L1-RSRP corresponding to the actual strongest reference signal identifier. If the strongest reference signal identifier predicted by the AI model is same as the actual strongest reference signal identifier, the L1-RSRP difference is 0. The L1-RSRP average difference can be obtained by a single prediction result based on the AI model, or by an average value of multiple prediction results based on the AI model.
(3) L1-SINR average difference: a difference between an actual L1-SINR corresponding to the strongest reference signal identifier predicted by the AI model and an actual L1-SINR corresponding to the actual strongest reference signal identifier. If the strongest reference signal identifier predicted by the AI model is same as the actual strongest reference signal identifier, the L1-SINR difference is 0. The L1-SINR average difference can be obtained by a single prediction result based on the AI model, or by an average value of multiple prediction results based on the AI model.
(4) Target L1-RSRP difference corresponding to a first percentile of a cumulative distribution function (CDF) curve of a L1-RSRP difference: in one implementation, the CDF curve of a L1-RSRP difference is a CDF curve obtained by the L1-RSRP differences of multiple prediction results based on the AI model in the above (2), namely, the L1-RSRP difference only includes a difference between the actual L1-RSRP corresponding to the strongest reference signal identifier predicted by the AI model and the actual L1-RSRP corresponding to the actual strongest reference signal identifier. In another implementation, the L1-RSRP difference refers to a difference between a predicted L1-RSRP corresponding to each reference signal identifier predicted at least once by the AI model and the actual L1-RSRP corresponding to each actual reference signal identifier respectively, that is, the AI model needs to output the L1-RSRP corresponding to each reference signal identifier. The first percentile is any percentile on the CDF curve of a L1-RSRP difference. In an example, the first percentile may be preconfigured by the access network device, for example, as 5%, 50% or 95%.
(5) Target L1-SINR difference corresponding to a second percentile of a CDF curve of a L1-SINR difference: In one implementation, the CDF curve of a L1-SINR difference is a CDF curve obtained by the L1-SINR differences of multiple prediction results based on the AI model in the above (3), namely, the L1-SINR difference only includes the difference between the actual L1-SINR corresponding to the strongest reference signal identifier predicted by the AI model and the actual L1-SINR corresponding to the actual strongest reference signal identifier. In another implementation, the L1-SINR difference refers to a difference between a predicted L1-SINR corresponding to each reference signal identifier predicted by the AI model at least once and the actual L1-SINR corresponding to each actual reference signal identifier, that is, the AI model needs to output the L1-SINR corresponding to each reference signal identifier. The second percentile is any percentile on the CDF curve of a L1-SINR difference. In an example, the second percentile may be preconfigured by the access network device, for example, as 5%, 50% or 95%.
(6) Average UE throughput difference: based on the actual L1-RSRP corresponding to the strongest reference signal identifier predicted by the AI model and the actual L1-RSRP corresponding to the actual strongest reference signal identifier, SINRs corresponding to two reference signal identifiers respectively are obtained, and Shannon capacities corresponding to the two reference signal identifiers respectively are calculated and therefore a difference between the Shannon capacities corresponding to the two reference signal identifiers respectively is this performance index. this performance index may be obtained by single prediction result based on the AI model or by multiple prediction results based on the AI model.

In one possible embodiment, the access network device determines the performance index based on at least one prediction result output by the monitoring model within a second preset time. The second preset time may be determined by the access network device based on a default value. For example, the second preset time is 1 second, and then if the AI model outputs 3 prediction results within 1 second, the performance index of the AI model can be determined based on the 3 prediction results.

In one possible embodiment, the access network device determines the performance index based on N2 prediction results output by the model, where N2 is a positive integer. N2 can be determined based on a default value. For example, when N2=4, 4 prediction results continuously output by the AI model are obtained to determine the performance index. For another example, when N2=5, if 10 prediction results are output by the AI model within a period of time, 5 prediction results may be selected randomly therefrom to determine the performance index, or 5 prediction results may be selected therefrom based on a preset rule to determine the performance index.

In one possible embodiment, when the access network device monitors that the performance index of the model is lower than a threshold of the performance index, the access network device updates the model based on at least one of a model parameter configuration identifier, a model parameter configuration, a model identifier or a model version identifier. Alternatively, when the access network device monitors that the performance index of the model is lower than the threshold of the performance index, the access network device returns to a traditional mode. In an example, the traditional mode refers to a non-AI mode or that the model identifier of the non-AI mode is 0.

In one possible embodiment, the terminal measures the beam qualities of the reference signal set B and reports the beam qualities and the reference signal identifiers of the reference signal set B to the access network device, and the access network device, after receiving the beam qualities and the reference signal identifiers of the reference signal set B, inputs the beam qualities and the reference signal identifiers of the reference signal set B into the AI model so as to obtain the beam qualities and the reference signal identifiers of the reference signal set A. The beam quality is L1-RSRP and/or L1-SINR.

In an example, the access network device inputs L1-RSRPs and/or L1-SINRs of reference signals in a fifth set at a third time into the model to obtain absolute values and/or relative relationships of L1-RSRPs and/or L1-SINRs of reference signals in a sixth set at a fourth time, where the fifth set is a subset of the sixth set. For example, the sixth set includes 16 reference signals of the fourth time, and the fifth set includes 4 reference signals of the third time. Thus, the terminal can predict beam qualities of 16 reference signals of the fourth time by beam qualities of 4 reference signals of the third time based on the AI model, where the third time is a historical time.

In an example, the access network device inputs L1-RSRPs and/or L1-SINRs of reference signals in a seventh set at the third time into the model to obtain absolute values and/or relative relationships of L1-RSRPs and/or L1-SINRs of reference signals in an eighth set at the fourth time. Beam widths of the reference signals in the seventh set are greater than beam widths of the reference signals in the eighth set, and a beam direction of each reference signal in the seventh set covers beam directions of multiple reference signals in the eighth set. The third time and the fourth time are in a same period.

In an example, the third time and the fourth time are in a same period, and the above period is used for a sending period of reference signals for beam measurement or a reporting period of beam measurement reporting.

In an example, the third time and the fourth time are not in a same period, for example, the third time is a historical time and the fourth time is a future time. It can be understood that the beam quality of the future time is predicted using the beam quality measured in the historical time.

In one possible embodiment, an AI model may also be set on the terminal and the AI model set on the terminal can cooperate with the AI model set on the access network device. In an example, the access network device sends model indication information to the terminal such that the terminal can, based on the model indication information, update the AI model set on the terminal. Alternatively, the model indication information is used to indicate at least one of a model parameter configuration identifier, a model parameter configuration, a model identifier and a model version identifier.

To sum up, in the embodiments of the present disclosure, the performance index of the model can be monitored such that the access network device can perform subsequent steps based on the performance of the model, so as to improve the performance of beam quality prediction based on AI model.

FIG. 14 is a structural block diagram illustrating a model monitoring apparatus according to an embodiment of the present disclosure. As shown in FIG. 6, the apparatus 1400 includes the following modules.

A monitoring module 1401 is configured for monitoring a performance index of a model.

In some examples, the performance index includes at least one of: a prediction accuracy; a Layer1—Reference Signal Received Power (L1-RSRP) average difference; a Layer1—Signal to Interference plus Noise Ratio (L1-SINR) average difference; a target L1-RSRP difference corresponding to a first percentile of a cumulative distribution function (CDF) curve of a L1-RSRP difference; a target L1-SINR difference corresponding to a second percentile of a CDF curve of a L1-SINR difference; or an average UE throughput difference.

In some examples, the monitoring module 1401 is further configured for, based on at least one prediction result output by the model within a first preset time, determining the performance index; or, based on N1 prediction results output by the model, determining the performance index, where N1 is a positive integer.

In some examples, a first sending module 1403 is configured for reporting a performance indication to the access network device, where the performance indication represents the terminal monitors the performance index of the model is lower than a threshold of the performance index.

In some examples, the first sending module 1403 is further configured for reporting the performance indication to the access network device over a Physical Uplink Control Channel (PUCCH) or Physical Uplink Shared Channel (PUSCH); or, reporting the performance indication to the access network device by information carrying Channel State Information (CSI); or, reporting the performance indication to the access network device by Uplink Media Access Control Control Element (UL MAC CE) and/or Schedule Request (SR).

In some examples, the performance indication includes at least one of: an indication of poor performance of the model; a performance index value of the model; at least one of a model identifier, a version identifier, a parameter configuration identifier or a parameter configuration of the model; at least one of a model identifier, a version identifier, a parameter configuration identifier or a parameter configuration of a recommended model; or a recommendation for returning to a traditional mode.

In some examples, the monitoring module 1401 is further configured to determine the threshold of the model's performance index.

In some examples, the monitoring module 1401 is further configured for, based on indication information of the access network device, determining the threshold of the performance index of the model; or, based on a default value, determining the threshold of the performance index of the model.

In some examples, the monitoring module 1401 is further configured for receiving the indication information from the access network device, where indication information includes at least one of Downlink Control Information (DCI), Media Access Control Control Element (MAC CE) and Radio Resource Control (RRC).

In some examples, a first receiving module 1402 is further configured for receiving model indication information from the access network device, where the model indication information indicates at least one of a model parameter configuration identifier, a model parameter configuration, a model identifier or a model version identifier; and based on the model indication information, updating the model; or, switching the model into a recommended model.

In some examples, the first receiving module 1402 is further configured for receiving a traditional mode indication from the access network device, where the traditional mode indication indicates the terminal to use a traditional mode; based on the traditional mode indication, switching to the traditional mode.

In some examples, the monitoring module 1401 is further configured for performing beam prediction based on the model.

In some examples, the monitoring module 1401 is further configured for inputting L1-RSRPs and/or L1-SINRs of reference signals in a first set at a first time into the model to obtain absolute values and/or relative relationship of L1-RSRPs and/or L1-SINRs of reference signals in a second set at a second time, where the first set is a subset of the second set.

In some examples, the monitoring module 1401 is further configured for inputting L1-RSRPs and/or L1-SINRs of reference signals in a third set at the first time into the model to obtain absolute values and/or relative relationship of L1-RSRPs and/or L1-SINRs of reference signals in a fourth set at the second time; where beam widths of the reference signals in the third set are greater than beam widths of the reference signals in the fourth set, and a beam direction of each reference signal in the third set covers beam directions of a plurality of reference signals in the fourth set.

In some examples, the first time and the second time are in a same period or the first time is a historical time.

To sum up, in the embodiments of the present disclosure, the performance index of the model is monitored such that the terminal can perform subsequent steps based on the performance of the model, so as to improve the performance of beam quality prediction based on the AI model.

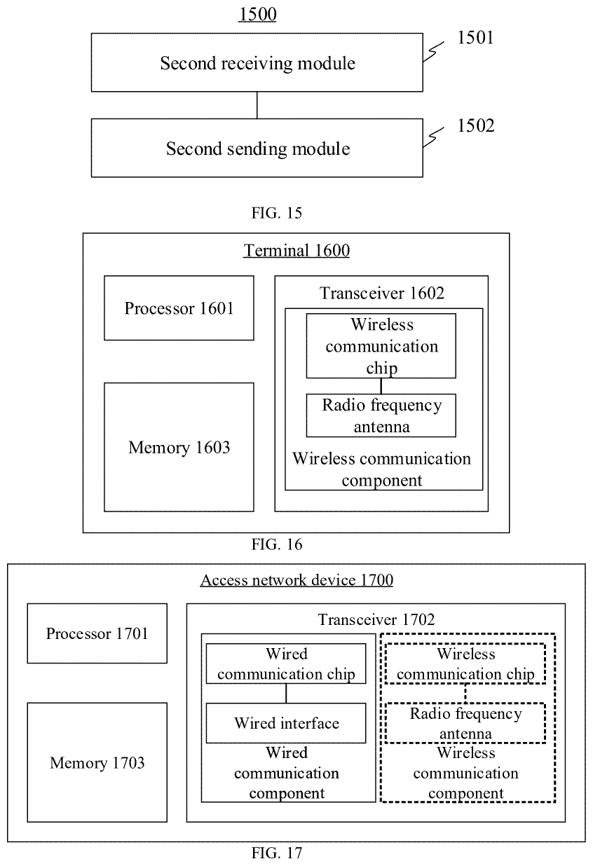

FIG. 15 is a structural block diagram illustrating a model monitoring apparatus according to an example of the present disclosure. As shown in FIG. 15, the apparatus 1500 includes the following modules.

A second receiving module 1501 is configured for receiving a performance indication reported by a terminal, where the performance indication represents that the terminal monitors a performance index of a model is lower than a threshold of the performance index.

In some examples, the performance index includes at least one of: a prediction accuracy; a Layer1—Reference Signal Received Power (L1-RSRP) average difference; a Layer1—Signal to Interference plus Noise Ratio (L1-SINR) average difference; a target L1-RSRP difference corresponding to a first percentile of a CDF curve of a L1-RSRP difference; a target L1-SINR difference corresponding to a second percentile of a CDF curve of a L1-SINR difference; an average UE throughput difference.

In some examples, a seconding sending module 1502 is configured for sending indication information to the terminal, where the indication information is for the terminal to determine the threshold of the performance index of the model.

In some examples, the seconding sending module 1502 is further configured for receiving the performance indication reported by the terminal over a PUCCH or PUSCH; or, receiving the performance indication reported by the terminal by information carrying CSI; or, receiving the performance indication reported by the terminal by UL MAC CE and/or SR.

In some examples, the performance indication includes at least one of: an indication of poor performance of the model; a performance index value of the model; at least one of a model identifier, a version identifier, a parameter configuration identifier and a parameter configuration of the model; at least one of a model identifier, a version identifier, a parameter configuration identifier and a parameter configuration of a recommended model; or a recommendation for returning to traditional mode.

In some examples, the seconding sending module 1502 is further configured for sending model indication information to the terminal, where the model indication information indicates at least one of a model parameter configuration identifier, a model parameter configuration, a model identifier or a model version identifier.

In some examples, the seconding sending module 1502 is further configured for sending a traditional mode indication to the terminal, where the traditional mode indication indicates the terminal to use a traditional mode.

To sum up, in the embodiments of the present disclosure, the performance index of the model can be monitored such that the access network device can perform subsequent steps based on the performance of the model, so as to improve the performance of beam quality prediction based on the AI model.

With reference to FIG. 16, FIG. 16 is a structural schematic diagram illustrating a terminal 1600 according to an embodiment of the present disclosure. The terminal 1600 includes a processor 1601, a transceiver 1602 and a memory 1603.

The processor 1601 includes one or more processing cores and performs various function applications and information processing by running soft programs and modules.

The transceiver 1602 includes a receiver and a transmitter. For example, the receiver and the transmitter can be implemented as one wireless communication component. The wireless communication component may include one wireless communication chip and a radio frequency antenna.

The memory 1603 is connected with the processor 1601 and the transceiver 1602.

The memory 1603 can be configured to store computer programs executable by the processor and the processor 1601 is configured to execute the computer programs to perform each operation executed by the terminal in the wireless communication system in the above method embodiments.

Furthermore, the memory 1603 may be implemented by any type of volatile or non-volatile storage devices or a combination thereof. The volatile or non-volatile storage devices may include but not limited to a magnetic disk or compact disk, electrically an erasable programmable read-only memory, an erasable programmable read-only memory, a static random access memory, a read-only memory, a magnetic memory, a flash memory and a programmable read-only memory.

For execution process of the transceiver 1602, reference can be made to each operation of the terminal in the above method.

As shown in FIG. 17, FIG. 17 is a structural schematic diagram illustrating an access network device 1700 according to an embodiment of the present disclosure. The access network device 1700 may include a processor 1701, a transceiver 1702 and a memory 1703.

The processor 1701 includes one or more processing cores and performs various function applications and information processing by running soft programs and modules.

The transceiver 1702 includes a receiver and a transmitter. For example, the transceiver 1702 may include one wired communication component which may include one wired communication chip and a wired interface (e.g. optical fiber interface). In an example, the transceiver 1702 may further include one wireless communication component which may include one wireless communication chip and a radio frequency antenna.

The memory 1703 is connected with the processor 1701 and the transceiver 1702.

The memory 1703 may be configured to store computer programs executable by the processor. The processor 1701 may be configured to execute the computer programs to perform each operation executed by the access network device in the wireless communication system in the above method embodiments.

Furthermore, the memory 1703 may be implemented by any type of volatile or non-volatile storage devices or a combination thereof. The volatile or non-volatile storage devices may include but not limited to magnetic disk or compact disk, electrically erasable programmable read-only memory, erasable programmable read-only memory, static random access memory, read-only memory, magnetic memory, flash memory and programmable read-only memory.

The embodiments of the present disclosure further provide a computer readable storage medium, storing at least one instruction, at least one segment of programs, code set or instruction set, and the at least one instruction, the at least one segment of programs, the code set or the instruction set is loaded and executed to cause the communication device to perform the above model monitoring methods.

The present disclosure further provides a computer program product which includes computer instructions stored in a computer readable storage medium. A processor of a computer device reads the computer instructions from the computer readable storage medium and executes the computer instructions to cause the computer program product to perform each operation executed by the terminal or access network device in the above methods.

The present disclosure further provides a chip run in a computer device to cause the computer device to perform each operation executed by the terminal or access network device in the above methods.

The present disclosure further provides computer programs executed by a processor of a computer device and a network device installed with the computer programs perform each operation executed by the terminal or access network device in the above methods.

Those skilled in the arts should be aware that in one or more examples, the functions described in the embodiments of the present disclosure can be implemented by hardware, software, firmware or any combination thereof. When implemented with software, these functions can be stored in a computer readable storage medium or as one or more instructions or codes on the computer readable storage medium for transmission. The computer readable storage medium includes a computer storage medium or communication medium, and the communication medium includes any medium facilitating transmission of the computer programs from one place to another. The storage medium may be an available medium accessible to general-purpose or dedicated computer.

The terms used in the embodiments of the present disclosure are used only for describing particular embodiments rather than to limit the present disclosure. The singular forms such as “a,” ‘said,” and “the” used in the present disclosure and the appended claims are also intended to include plural, unless the context clearly indicates otherwise. It is also to be understood that the term “and/or” as used herein refers to and includes any or all possible combinations of one or more associated listed items.

It is to be understood that, although the terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the terms “if” and “responsive to” as used herein may be interpreted as “when” or “upon” or “in response to determining”.

The foregoing descriptions are only examples of the present disclosure but not intended to limit the present disclosure. Various modifications, equivalent substitutions and improvements made within the spirit and principle of the present disclosure shall all fall within the scope of protection of the present disclosure.

1. A model monitoring method, performed by a terminal and comprising:
monitoring a performance index of a model.

2. The model monitoring method of claim 1, wherein the performance index comprises at least one of:
a prediction accuracy;
a Layer1—Reference Signal Received Power (L1-RSRP) average difference;
a Layer1—Signal to Interference plus Noise Ratio (L1-SINR) average difference;
a target L1-RSRP difference corresponding to a first percentile of a cumulative distribution function (CDF) curve of a L1-RSRP difference;
a target L1-SINR difference corresponding to a second percentile of a CDF curve of a L1-SINR difference; or
an average User Equipment (UE) throughput difference.

3. The model monitoring method of claim 1, wherein monitoring the performance index of the model comprises:
based on at least one prediction result output by the model within a first preset time, determining the performance index; or,
based on N1 prediction results output by the model, determining the performance index, wherein N1 is a positive integer.

4. The model monitoring method of claim 1, further comprising:
reporting a performance indication to an access network device, wherein the performance indication represents that the terminal monitors the performance index of the model is lower than a threshold of the performance index.

5. The model monitoring method of claim 4, wherein reporting the performance indication to the access network device comprises:
reporting the performance indication to the access network device over a Physical Uplink Control Channel (PUCCH) or Physical Uplink Shared Channel (PUSCH); or,
reporting the performance indication to the access network device by information carrying Channel State Information (CSI); or,
reporting the performance indication to the access network device by Uplink Media Access Control Control Element (UL MAC CE) and/or Schedule Request (SR).

6. The model monitoring method of claim 4, wherein the performance indication comprises at least one of:
an indication of poor performance of the model;
a performance index value of the model;
at least one of a model identifier, a version identifier, a parameter configuration identifier or a parameter configuration of the model;
at least one of a model identifier, a version identifier, a parameter configuration identifier or a parameter configuration of a recommended model; or
a recommendation for returning to a traditional mode.

7. The model monitoring method of claim 4, further comprising:
determining the threshold of the performance index of the model;
wherein determining the threshold of the performance index of the model comprises:
based on indication information of the access network device, determining the threshold of the performance index of the model; or,
based on a default value, determining the threshold of the performance index of the model.

8. (canceled)

9. The model monitoring method of claim 7, further comprising:
receiving the indication information from the access network device, wherein the indication information comprises at least one of Downlink Control Information (DCI), Media Access Control Control Element (MAC CE) or Radio Resource Control (RRC).

10. The model monitoring method of claim 4, further comprising:
receiving model indication information from the access network device, wherein the model indication information indicates at least one of a model parameter configuration identifier, a model parameter configuration, a model identifier or a model version identifier; and
based on the model indication information, updating the model; or, switching the model into a recommended model; or,
receiving a traditional mode indication from the access network device, wherein the traditional mode indication indicates the terminal to use a traditional mode;
based on the traditional mode indication, switching to the traditional mode.

11. (canceled)

12. The model monitoring method of claims 1, further comprising:
performing beam prediction based on the model.

13. The model monitoring method of claim 12, wherein performing the beam prediction based on the model comprises:
inputting L1-RSRPs and/or L1-SINRs of reference signals in a first set at a first time into the model to obtain absolute values and/or relative relationships of L1-RSRPs and/or L1-SINRs of reference signals in a second set at a second time, wherein the first set is a subset of the second set;
wherein the first time and the second time are in a same period or the first time is a historical time.

14. The model monitoring method of claim 12, wherein performing the beam prediction based on the model comprises:
inputting L1-RSRPs and/or L1-SINRs of reference signals in a third set at a first time into the model to obtain absolute values and/or relative relationships of L1-RSRPs and/or L1-SINRs of reference signals in a fourth set at a second time, wherein beam widths of the reference signals in the third set are greater than beam widths of the reference signals in the fourth set, and a beam direction of each reference signal in the third set covers beam directions of a plurality of reference signals in the fourth set;
wherein the first time and the second time are in a same period or the first time is a historical time.

15. (canceled)

16. A model monitoring method, performed by an access network device and comprising:
receiving a performance indication reported by a terminal, wherein the performance indication represents that the terminal monitors a performance index of a model is lower than a threshold of the performance index.

17. The model monitoring method of claim 16, wherein the performance index comprises at least one of:
a prediction accuracy;
a Layer1—Reference Signal Received Power (L1-RSRP) average difference;
a Layer1—Signal to Interference plus Noise Ratio (L1-SINR) average difference;
a target L1-RSRP difference corresponding to a first percentile of a cumulative distribution function (CDF) curve of a L1-RSRP difference;
a target L1-SINR difference corresponding to a second percentile of a CDF curve of a L1-SINR difference; or
an average User Equipment (UE) throughput difference.

18. The model monitoring method of claim 16, further comprising:
sending indication information to the terminal, wherein the indication information is for the terminal to determine the threshold of the performance index of the model; or
sending model indication information to the terminal, wherein the model indication information indicates at least one of a model parameter configuration identifier, a model parameter configuration, a model identifier or a model version identifier; or
sending a traditional mode indication to the terminal, wherein the traditional mode indication indicates the terminal to use a traditional mode.

19. The model monitoring method of claim 16, wherein receiving the performance indication reported by the terminal comprises:
receiving the performance indication reported by the terminal over a Physical Uplink Control Channel (PUCCH) or Physical Uplink Shared Channel (PUSCH); or,
receiving the performance indication reported by the terminal by information carrying Channel State Information (CSI); or,
receiving the performance indication reported by the terminal by Uplink Media Access Control Control Element (UL MAC CE) and/or Schedule Request (SR).

20. The model monitoring method of claim 16, wherein the performance indication comprises at least one of:
an indication of poor performance of the model;
a performance index value of the model;
at least one of a model identifier, a version identifier, a parameter configuration identifier and a parameter configuration of the model;
at least one of a model identifier, a version identifier, a parameter configuration identifier and a parameter configuration of a recommended model; or
a recommendation for returning to a traditional mode.

21-24. (canceled)

25. A terminal, comprising: a processor; a transceiver connected with the processor; wherein the processor is configured to load and execute executable instructions to perform operations comprising:
monitoring a performance index of a model.

26. An electronic device, comprising:
a processor; and
a transceiver connected with the processor;
wherein the execute executable instructions when executed by the processor cause the electronic device to act as the access network device and perform the model monitoring method of claim 16.

27. A computer readable storage medium, storing at least one instruction, at least one segment of program, a code set or an instruction set, wherein the at least one instruction, the at least one segment of program, the code set or the instruction set when executed by a processor of the terminal cause the terminal to perform the model monitoring method of claim 1
